(19) United States
(12) Patent Application Publication
(10) Pub. No.: US 2025/0348401 A1
(43) Pub. Date: Nov. 13, 2025

(54) Automatic Performance Profiling of Backend Sessions

(71) Applicant: SAP SE, Walldorf (DE)

(72) Inventor: Tom Spiegler, Langebrück (DE)

(73) Assignee: SAP SE, Walldorf (DE)

(21) Appl. No.: 18/660,078

(22) Filed: May 9, 2024

(51) Int. Cl. G06F 11/34

(52) U.S. Cl. CPC G06F 11/3409

(57) ABSTRACT

Automated performance profiling can be performed for software modules imported during a backend session of a software platform. An import request for an entity (e.g., a requested function or requested class) received from a client application during the backend session can be intercepted by an automatic performance profiling process which wraps a software module implementing the entity with profiling. The request can include an indication to enhance the entity with profiling. Responsive to the request, the server identifies and imports the software module implementing the entity with a software engine and determines whether the software module includes profiling. If the software module does not yet include profiling, the server transforms the requested entity into a profiling-enhanced entity by wrapping the requested entity with profiling. The profiling-enhanced entity is then output to fulfill the request.

### FIELD

The field generally relates to performance profiling for backend sessions of a software platform.

### BACKGROUND

Performance analysis of backend components, including identifying performance bottlenecks, is crucial to software product development. A performance profiler that measures runtimes of methods can be executed to gain insights into function calls and expensive statements of a user session. Towards this end, performance profiler statements are sometimes manually added to code in specific places; when the code is executed, the statements can optionally be activated to record runtimes of the corresponding methods. With millions lines of code and thousands of functions, only a limited set of core functions would be measured by performance profiling due to the requirement that the profiling statements be manually added to the code. This manual effort adds significant cost during product development, and increases room for bugs that are unrelated to the actual production code.

In addition, the results of manual performance profiling tend to be coarse-grained. For example, if a performance profile indicates that a method took 500 milliseconds but the method calls several other methods that are not profiled during execution, a developer cannot immediately identify whether the method itself, or some nested function call within it, causes the lengthy runtime. To obtain this information, the developer would need to manually add profiling statements to the inner methods to find the critical path. In examples where these inner methods are not accessible to the developer (e.g., because they do not belong to the developer's team-owned code), the additional profiling statements would need to be discarded after the performance analysis. In such examples, when another developer revisits the issue again at a later time, the changes would need to be added again.

### BRIEF DESCRIPTION OF THE DRAWINGS

FIG. 1 is a block diagram of an example system implementing automatic performance profiling of requested entities during a backend session.

FIG. 2 is a flowchart of an example method of implementing automatic performance profiling of requested entities imported during a backend session.

FIG. 3 is a flow diagram of an example method of wrapping imported software modules with profiling.

FIG. 4 is a flowchart of an example method of wrapping a function with profiling and a flowchart of an example method of wrapping a class or superclass with profiling.

FIG. 5 is a flow diagram depicting wrapping and execution of an example software module and the methods thereof.

FIG. 6 is a block diagram of an example computing system in which described embodiments can be implemented.

FIG. 7 is a block diagram of an example cloud computing environment that can be used in conjunction with the technologies described herein.

### DETAILED DESCRIPTION

### Example 1)—Overview

Automated performance profiling can be performed for software modules imported during a backend session of a software platform in which a client application communicates with a server of the software platform. In particular, an import request for an entity (e.g., function or class) received from a client application during a backend session can include an indication to enhance the requested entity with profiling. The request can be intercepted by an automatic performance profiling process which wraps the software module implementing the requested entity with profiling.

Responsive to the request, the server imports the software module implementing the requested function with a software engine and determines whether the software module was previously imported and enhanced with profiling. If it is determined that the software module was previously imported and enhanced with profiling, the corresponding profiling-enhanced software module that was previously generated is retrieved from memory. Otherwise, the server proceeds to transform the software module into a profiling-enhanced software module by wrapping any entities within the software module with profiling. In either case, the profiling-enhanced software module is then output (e.g., transmitted to the client application) to fulfill the request.

A software module can be understood as a container holding logic such as functions and classes. Wrapping the software module with profiling can include wrapping the requested entity with profiling, as well as wrapping other entities within the software module with profiling. In some examples, the software module includes a single entity (e.g., a single function); in other examples, the software module includes multiple entities. As used herein, wrapping a software module with profiling includes executing profiling functions for entities within the software module that are functions, classes, methods, or superclasses. Towards this end, for entities of these types, the profiling function receives the entity as an argument and returns a profiling-enhanced version of the entity (referred to alternatively herein as the profiling-enhanced entity). The profiling function, when executed, generates the profiling-enhanced entity by adding computer-executable instructions to the entity (and thus, to the software module containing the entity) for measuring performance data associated with the entity.

Depending on the contents of the software module, wrapping the software module can involve a single execution or multiple executions of the profiling function. For example, if the software module contains a single entity (e.g., a single function), the profiling function may be executed only once to wrap the entity with profiling by inserting computer-executable instructions for measuring performance data associated with the entity (e.g., an execution time of the entity) into the software module. In contrast, if the software module contains multiple entities, or if the software module contains a single entity which has one or more child entities (e.g., a class with one or more methods), wrapping the software module with profiling can include multiple executions of the profiling function. For each of the multiple executions, a corresponding one of the multiple entities will serve as the argument of the profiling function. It will be appreciated that in some examples, only a subset of the entities of the software module may be wrapped with profiling.

As an illustrative example, consider a software module containing a function and a class, where the class includes two methods. Wrapping the software module with profiling in accordance with the technologies described herein can include wrapping the function with profiling, wrapping the class with profiling, and wrapping the methods of the class with profiling. Accordingly, for entities of the software module (e.g., for the function, the class, and each method of the class), the profiling function can be executed with the entity as an argument. The execution of the profiling function with the entity as the argument causes computer-executable instructions for measuring performance data associated with the entity to be inserted into the code representing the entity.

After wrapping entities within the software module, the software module is transformed into a profiling-enhanced software module which is configured to measure performance data (e.g., execution time) associated with the individual entities it contains. For example, the sum of all the individual entity execution times can be calculated to obtain an overall execution time associated with the software module; the individual entity execution times are also of interest, as they allow developers to review code performance with a high level of granularity. The performance data can also include metrics such as the number of function calls associated with an entity, among other metrics.

### Example 2)—Example System Implementing Automatic Performance Profiling of Software Modules

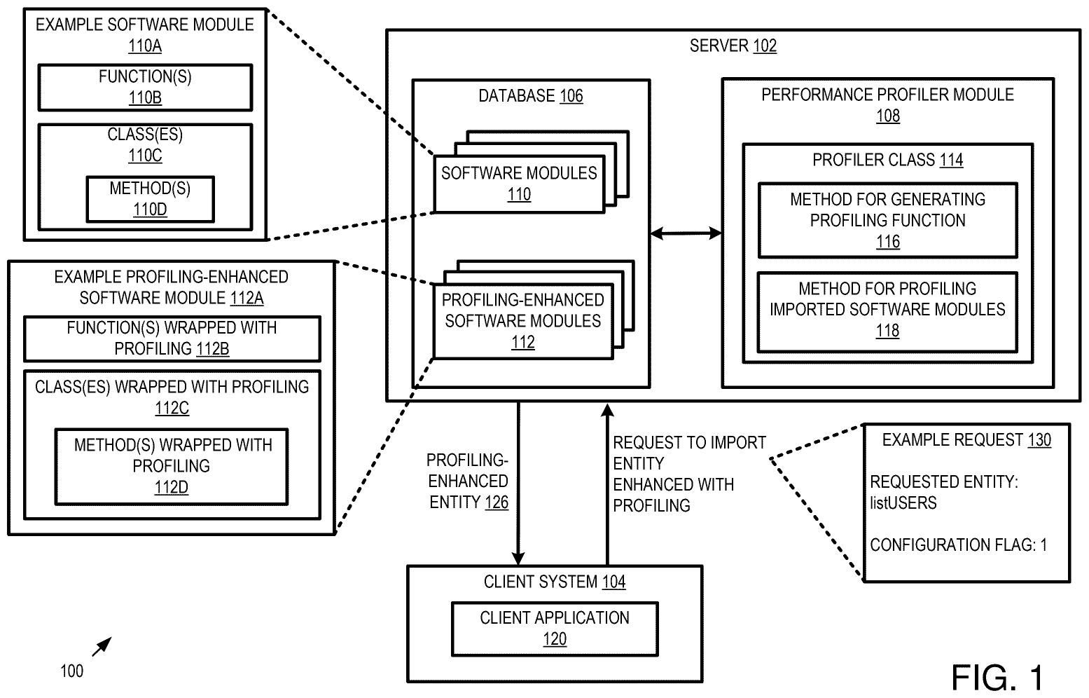

FIG. 1 is a block diagram of an example system 100 implementing automatic performance profiling of requested entities. In some examples, system 100 is a software platform (e.g., a data analytics platform). The system 100 includes a server 102 and a client system 104, among other components.

Server 102 can be a data server which is part of a backend system within the software platform. Server 102 includes a database 106 and a performance profiler module 108, among other components. In the depicted example, database 106 stores a plurality of software modules 110 and a plurality of profiling-enhanced software modules 112. While not depicted in FIG. 1, other data can also be stored in database 106 or in another database of server 102 (e.g., datasets associated with a tenant of the software platform).

Each software module 110 can include computer-executable instructions (e.g., executable code). The executable code in a given software module 110 can include one or more entities made up of computer-executable instructions such as functions, classes, methods, and the like. Execution of the code within the software module 110 by a computing device can cause the computing device to perform operations (e.g., operations which manipulate data or achieve other desired functions in the context of a software platform).

Performance profiler module 108 can be a software module (e.g., an object or other data structure) comprising a class definition of a profiler class 114. In the depicted example, profiler class 114 includes a method for generating a profiling function 116 and a method for profiling imported software modules 118; however, profiler class 114 and performance profiler module 108 can also include other entities.

Client system 104 can be configured to execute a client application 120 to generate and display different data visualizations, reports, analytics, etc. For example, client system 104 may execute client application 120 to access, change, and otherwise use data in the database 106 of server 102. Client system 104 can include any suitable computing device capable of executing client application 120 (e.g., a desktop computer, a laptop computer, a tablet computer, or a smartphone). Client application 120 may comprise an application associated with a cloud-based analytics software platform, or another type of application.

A user of client system 104 can operate a user interface (UI) to send a connection request to server 102 to initiate a backend session between the client application 120 and the server 102 (e.g., a lightweight backend session in which the client application 120 communicates with the backend system of the software platform containing server 102). Once the backend session has been established, the client application 120 can send data queries or other requests to the server 102 (e.g., responsive to user input received via a UI or independent of user input). The requests sent from client application 120 to server 102 can include requests to import entities such as functions or classes; such requests are alternatively referred to herein as import requests. For example, a user of client system 104 may operate a UI to send an import request, via client application 120, to server 102.

It will be appreciated that an import request is different from a data query. For example, when a data query is sent to a server via a client application, all logic is executed on the server itself. The server returns the requested data in a structured format (e.g., as an object in JavaScript Object Notation (JSON) format). In contrast, when a client application sends an import request to a server, the server returns logic (e.g., in a container such as a software module) to be executed by the client application.

The import request can specify a particular entity (e.g., function or class). The entity specified in the import request may be implemented by and included in a software module. As shown, an example software module 110A can include one or more entities such as one or more functions 110B and/or one or more classes 110C. The one or more classes 110C can each include one or more methods 110D, which can be static methods or instance methods. In other examples, a software module can include fewer or more entities than what is depicted in example software module 110A. For example, a software module can include one or more functions but no classes, one or more classes but no functions, or another type of entity or combination of entities.

The import request can also include an indication of whether the requested entity (e.g., requested function or requested class) should be imported with profiling enhancement. For example, the request can include a configuration flag which is ON (e.g., set with a value of 1) when a profiling-enhanced version of the software module including the requested entity is to be imported, and OFF when the original unmodified software module including the requested entity is to be imported. In some examples, the configuration flag or other type of indication can have a default value of ON, such that imported software modules are automatically imported with profiling enhancement unless the import request has been modified to turn off this functionality.

In the depicted example, client system 104 transmits a request to import an entity enhanced with profiling to server 102. The request can be embodied by a data structure such as a software object. An example request 130 is depicted which specifies a requested entity and includes a configuration flag. For illustrative purposes, example request 130 indicates that the requested entity to be imported is a listUsers function. In the example request 130, the configuration flag has a value of 1 (ON), indicating that a profiling-enhanced version of the listUsers function should be returned.

Upon receipt of an import request with an indication to enhance the requested entity with profiling, such as example request 130, server 102 can identify (e.g., look up) the software module implementing the requested entity and execute the performance profiler module 108 for the identified software module. For example, upon receipt of example request 130, server 102 can look up the software module implementing the requested listUsers function (e.g., a software module entitled “User”) and then execute the performance profiler module 108 for the User software module. In other examples, the performance profiler module 108 may be executed for the requested entity alone, such that other entities within the identified software module are not profiled.

Execution of the performance profiler module 108 can include instantiating the profiler class 114 (e.g., instantiating an object of the profiler class 114). After instantiating the profiler class 114, the server 102 can execute the method for generating the profiling function 116 to generate the profiling function for the software module implementing the requested entity (e.g., the User software module which implements the requested function listUsers in the depicted example), and then execute the method for profiling imported software modules 118 to transform the software module into a profiling-enhanced software module. The software module implementing the requested entity (e.g., the requested function or requested class) is referred to herein as “the requested software module” for the sake of brevity.

As described herein, the method for profiling imported software modules 118 can include a determination of whether the requested software module has already been profiled. For example, this can include the server 102 searching the profiling-enhanced software modules 112 stored in database 106 for a profiling-enhanced version of the requested software module. If a profiling-enhanced software module including a profiling-enhanced version of the requested entity is present in the database 106, the server 102 can retrieve that module and output the profiling-enhanced entity at 126 (e.g., transmit the previously generated profiling-enhanced version of the requested entity to the client system 104). Similarly, if a profiling-enhanced version of an entity within a software module being profiled (e.g., a function, class, or method) is already present in the database 106, the server 102 can retrieve the profiling-enhanced entity and incorporate it in the profiling-enhanced version of the software module that is being generated. Such operation can advantageously reduce unnecessary redundancy.

Otherwise, the server 102 can proceed to wrap the requested entity with profiling. As described further herein, this can include the server 102 executing the profiling function for the requested entity to generate a profiling-enhanced entity. Optionally, the server can also wrap other entities (e.g., functions, classes, or methods) contained in the requested software module at this stage to generate a profiling-enhanced software module. As shown, an example profiling-enhanced software module 112A generated by this approach can include one or more functions wrapped with profiling 112B and one or more classes wrapped with profiling 112C. The one or more classes wrapped with profiling 112C can each include one or more methods wrapped with profiling 112D. It will be appreciated that a profiling-enhanced software module can include fewer or more entities than what is depicted in example software module 112A, depending on the contents of the original software module to which it corresponds. For example, a profiling-enhanced software module can include one or more wrapped functions but no classes, one or more wrapped classes but no functions, or another type of wrapped entity or combination of wrapped entities.

After generating the profiling-enhanced entity, the server 102 outputs the profiling-enhanced entity at 126 to client system 104 (e.g., to client application 120). The client application 120 can then execute the code within the profiling-enhanced entity to perform the functionality associated with the requested entity while measuring the associated performance data (e.g., execution time).

Typically, software modules and entities are wrapped with profiling eagerly (i.e., on demand when they are imported). However, in some environments (e.g., JavaScript), it is possible to lazily import software modules at the time a function is executed. In this case, imported software modules may be wrapped lazily only when required (e.g., due to execution of an associated function). Accordingly, in such examples, execution of a profiling-enhanced entity of a software module by the client system 104 can trigger profiling of a software module implementing the entity. Further, if the profiling-enhanced entity includes a function call which requires import of another software module, the performance profiling process may be repeated for the other software module during execution of the profiling-enhanced entity at the client system 104.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. Additional components can be included to implement security, redundancy, load balancing, report design, and the like.

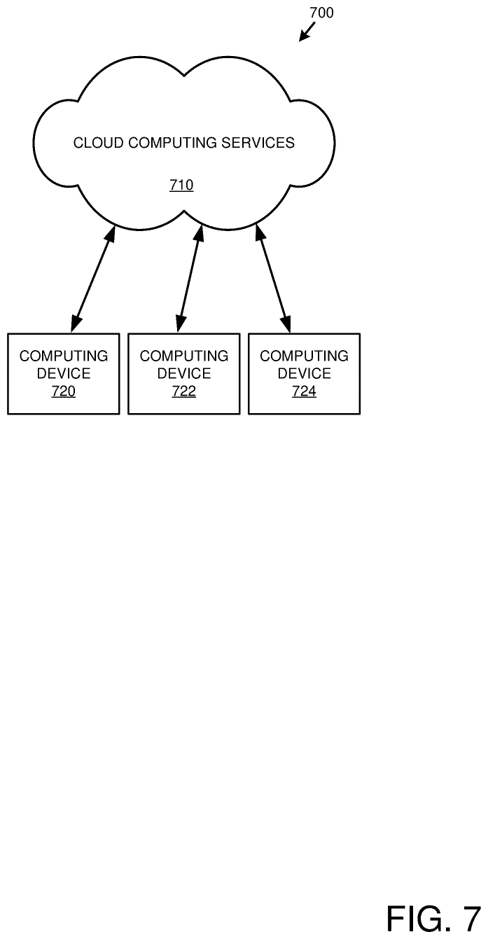

The described systems can be networked via wired or wireless network connections, including the Internet. For example, the system 100 can be implemented in a cloud environment, as detailed below with reference to FIG. 7. Alternatively, the systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the performance profiler module 108, software modules 110, profiling-enhanced software modules 112, other data associated with server 102, and the like can be stored in one or more computer-readable storage media or computer-readable storage devices. The technologies described herein can be generic to the specifics of operating systems or hardware and can be applied in any variety of environments to take advantage of the described features.

### Example 3)—Example Method Implementing Automatic Performance Profiling

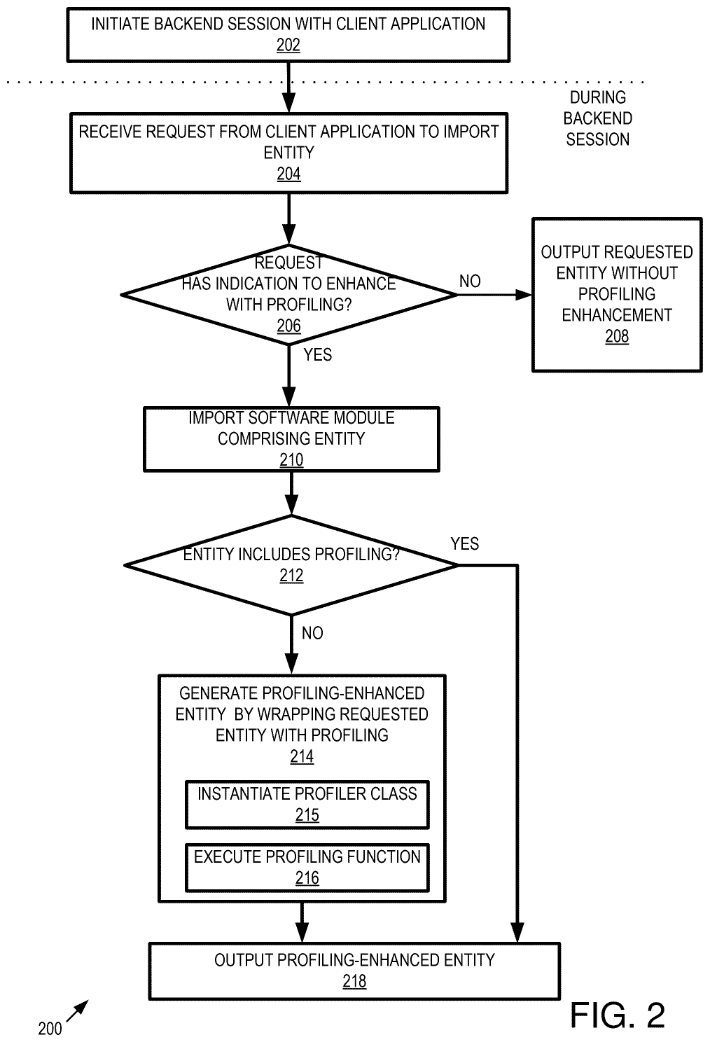

FIG. 2 is a flowchart of an example method 200 of implementing automatic performance profiling of entities imported during a backend session and can be performed, for example, by the system of FIG. 1. For example, the server 102 of FIG. 1 can perform method 200 to establish a backend session with a client application and intercept entity imports requested by the client application to wrap the requested entities with profiling. The server can be associated with a software platform, and the client application can be executed on a client system associated with a tenant of the software platform.

In the example, at 202, a backend session is initiated with a client application. For example, a user of a client system can operate a UI to send a connection request to a server to initiate a backend session between a client application executing on the client system and the server. The backend session can be a lightweight backend session in which the client application communicates with a backend system of the software platform (e.g., a backend system which includes the server). As indicated, the following steps of method 200 are performed during the backend session (e.g., while the backend session is active between the client application and the server).

At 204, a request to import an entity is received from the client application. The request can specify the entity to be imported (referred to herein as the “requested entity”). Alternatively, the request can specify a plurality of entities to be imported, and the server can correlate the entities with one or more existing stored software modules. The entity can be a function or class which is implemented by a software module. Alternatively, the entity can be a software module that includes one or more entities.

At 206, the method includes determining whether the request includes an indication to enhance the requested entity with profiling. The indication can be a configuration flag with an ON value (e.g., a value of 1), or another type of indication. If the answer at 206 is NO, the method proceeds to output the requested entity without profiling enhancement at 208. For example, the server can identify the software module that implements the requested entity, retrieve the identified software module from storage (e.g., from a database such as database 106 of FIG. 1), extract the requested entity from the identified software module, and transmit the requested entity to the client application. The client application can then execute the requested entity without automatic performance profiling.

Otherwise, if the answer at 206 is YES, indicating that the requested entity should be enhanced with profiling, the method proceeds to import the software module comprising the requested entity at 210. For example, the server can identify the software module that comprises the requested entity and then retrieve it from a location where it is stored (e.g., database 106 of FIG. 1).

At 212, it is determined whether the imported entity includes profiling (e.g., whether the imported entity was previously enhanced with profiling). For example, the server can examine the imported entity to determine whether it includes performance profiling code (e.g., computer-executable instructions to measure performance data associated with the entity). If it is determined that the imported entity was previously enhanced with profiling (and thus is a profiling-enhanced entity), the profiling-enhanced entity is output at 218.

Otherwise, if the answer at 212 is NO, indicating that the requested entity was not previously enhanced with profiling, the method proceeds to 214. At 214, a profiling-enhanced version of the requested entity is generated by wrapping the requested entity with profiling. As described further herein, this can include instantiating a profiler class at 215 (e.g., profiler class 114 of FIG. 1) and executing a profiling function at 216. Depending on the type of the requested entity, wrapping the requested entity with profiling can include executing the profiling function multiple times (e.g., once for each entity exported by the software module). For example, if the entity is a class, wrapping the entity with profiling can optionally include executing the profiling function for individual methods within the class. Alternatively, the methods within the class may be profiled later (e.g., when they are called).

At 218, the profiling-enhanced entity is output. For example, the server can transmit the profiling-enhanced entity to the client application from which the request was received. The client application can then execute the requested entity with profiling enhancement. Execution of the profiling-enhanced entity by the client application (in particular, execution of the code which was injected into the profiling-enhanced entity during execution of the profiling function) produces a performance profile for the requested entity.

The performance profile for the requested entity can include performance data for the requested entity such as execution time and number of function calls. For example, a profiling-enhanced version of a requested function can include instructions to record an execution start time of the requested function, instructions to record an execution end time of the requested function, and instructions to determine the execution time associated with the requested function as a difference between the execution end time and the execution start time.

In some examples, execution of the profiling-enhanced entity involves function calls for other entities of the software module. In such examples, performance profiles may be produced for the other entities called during execution of the requested entity. Accordingly, in addition to overall performance data for the requested entity (e.g., the overall execution time, number of function calls, etc. for the requested entity), the performance profile can include individual performance data for entities associated with the requested entity such as functions, classes, and methods within classes. In particular, the performance profile can include measurements of the execution time associated with individual entities and other data such as the number of function calls associated with the individual entities.

In some examples, the performance profile is stored in a secured table in a database. The data therein can either be accessed directly by users with permission to read any database tables (e.g., administrative users), or by a user that is specifically privileged to read the data (e.g., support users of the application provider). Restricting access to the performance profile in this way can prevent unauthorized users (e.g., users of the client application) from obtaining deep insights into the behavior of the client application, which could be maliciously used. Alternatively, in some examples, users of the client application may be given access to certain aspects of the performance profile.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a request can be described as sending a request depending on perspective.

### Example 4)—Example Method of Wrapping an Imported Software Module with Profiling

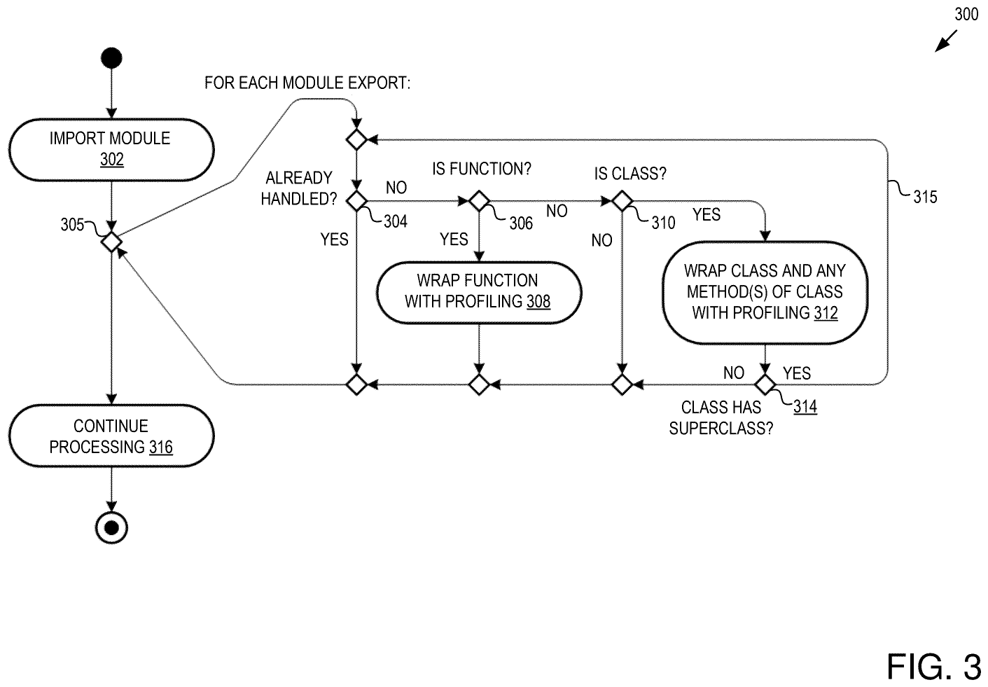

FIG. 3 is a flow diagram of an example method 300 of wrapping an imported software modules with profiling and can be performed, for example, by the system of FIG. 1 (e.g., by a server such as server 102 of FIG. 1). In particular, method 300 can be performed during an active backend session between a server and a client application, e.g., at steps 210-216 of FIG. 2.

In the example, at 302, a software module is imported. Next, a series of actions are performed for entities exported by the module (e.g., functions, classes, or other entities exported by the module). At 304, the method includes determining whether the entity was already handled (e.g., already enhanced with profiling), as described above with reference to step 212 of FIG. 2. If the answer at 304 is YES, the method proceeds to node 305. If the imported software module includes any additional entities, the method returns to 304 to begin the wrapping process for the next entity of the software module. If the imported software module does not include any other entities, the method proceeds from node 305 to 316 to continue processing (e.g., to output the profiling-enhanced software module).

Otherwise, if the answer at 304 is NO, the method proceeds to 306 to determine whether the entity is a function. If the answer at 306 is YES, the method proceeds to wrap the function with profiling at 308. As described herein, this can include the server executing the profiling function with the function as an argument to generate a profiling-enhanced version of the function which includes code for measuring performance data associated with the function such as execution time and number of function calls. After 308, the method proceeds to node 305 to repeat the wrapping process for any additional entities of the module (or, to proceed to 316 to continue processing if all entities of the module have already been processed). It will be appreciated that the profiling function is distinct from the function being wrapped with profiling at 308. That is, the function being wrapped with profiling is implemented by and included in the imported software module, whereas the profiling function is executed to inject code into entities within the imported software module (such as the function being wrapped with profiling at 308).

Returning to 306, if the answer is NO indicating that the entity is not a function, the method proceeds to 310 to determine whether the entity is a class. If the answer at 310 is NO, the method proceeds to node 305 to repeat the wrapping process for any additional entities of the module (or, to proceed to 316 to continue processing if all entities of the module have already been processed).

Otherwise, if the answer at 310 is YES indicating that the entity is a class, the method proceeds to 312 to wrap the class and any methods of the class with profiling. This can include the server first executing the profiling function with the class as an argument to generate a profiling-enhanced version of the class, and then, for each method of the class, executing the profiling function with the method as an argument to generate a profiling-enhanced version of the method. As described herein, the profiling-enhanced version of each entity can include code for measuring performance data associated with the entity such as its execution time and number of function calls.

The method then proceeds to 314 to determine whether the class has a superclass (e.g., whether the class is a subclass of a superclass). If the answer at 314 is NO, the method proceeds to node 305 to repeat the wrapping process for any additional entities of the module or continue processing if all entities of the imported software module have already been processed. Otherwise, if the answer at 314 is YES indicating that the class has a superclass, the method returns to 304 via branch 315 to handle the superclass. If the superclass has already been handled, the method proceeds to node 305 to repeat the wrapping process for any additional entities of the module or continue processing if all entities of the imported software module have already been processed.

Otherwise, if the superclass has not already been handled, the method ultimately proceeds to 312 to wrap the superclass and any methods of the superclass with profiling. After the wrapping process is completed for the superclass, the method again proceeds to node 305 to repeat the wrapping process for any additional entities of the imported software module (or, to proceed to 316 to continue processing if all entities of the module have already been processed).

After all entities exported by the imported software module have been wrapped (e.g., all entities which were not previously wrapped), the method proceeds to 316 to continue processing (e.g., to output the profiling-enhanced software module). After 316, the method ends.

### Example 5)—Example Methods of Wrapping Functions and Classes with Profiling

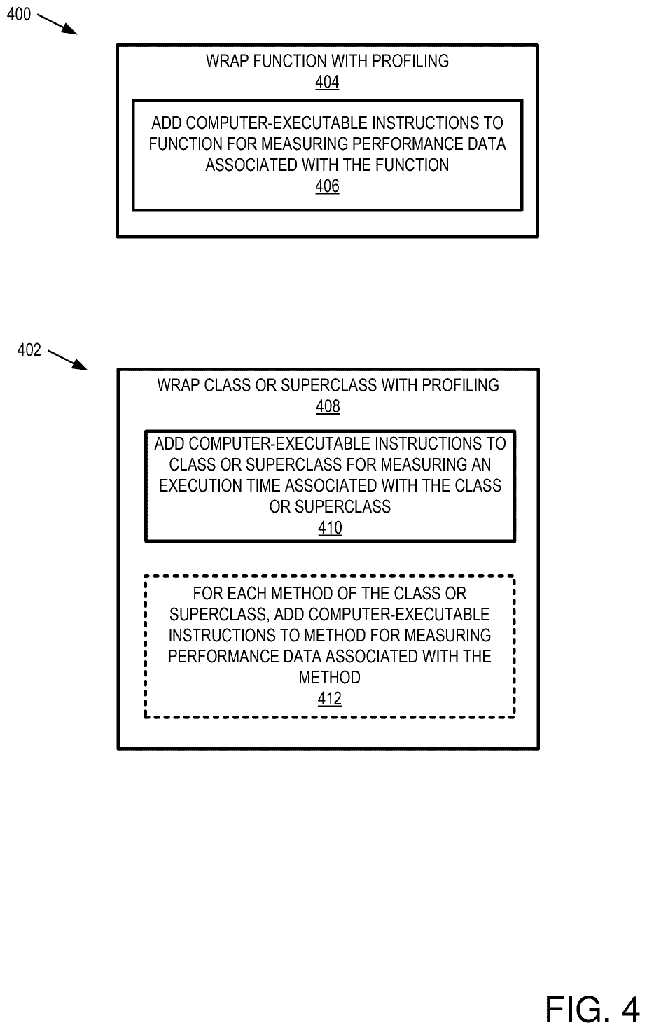

FIG. 4 depicts flowcharts of an example method 400 of wrapping a function exported by a software module with profiling and an example method 402 of wrapping a class or superclass exported by a software module with profiling and can be performed, for example, by the system of FIG. 1 (e.g., by a server such as server 102 of FIG. 1). In particular, methods 400 and 402 can be performed at steps 308 and 312 of FIG. 3, respectively.

Method 400 includes wrapping a function (e.g., a requested function) with profiling at 404. As shown, this can include, at 406, adding computer-executable instructions to the function for measuring performance data associated with the function. The performance data can include, for example, an execution time of the function, a number of function calls performed during execution of the function, details regarding the function, and other data. It will be appreciated that the function wrapped with profiling at 404 is distinct from the profiling function.

Method 402 includes wrapping a class or superclass with profiling at 408. As shown, this can include, at 410, adding computer-executable instructions to the class or superclass measuring performance data associated with the class or superclass. The performance data can include, for example, an execution time associated with the class or superclass, a number of function calls associated with the class or superclass, details regarding the class or superclass, and other data.

In examples where the class or superclass includes one or more methods, method 402 further includes wrapping each method within the class or superclass at 412. Accordingly, for each method of the class or superclass, step 412 includes adding computer-executable instructions to the method for measuring performance data associated with the method. The performance data can include, for example, an execution time associated with the method, a number of function calls associated with the method, details regarding the method, and other data.

### Example 6)—Example Wrapping and Profiling Process

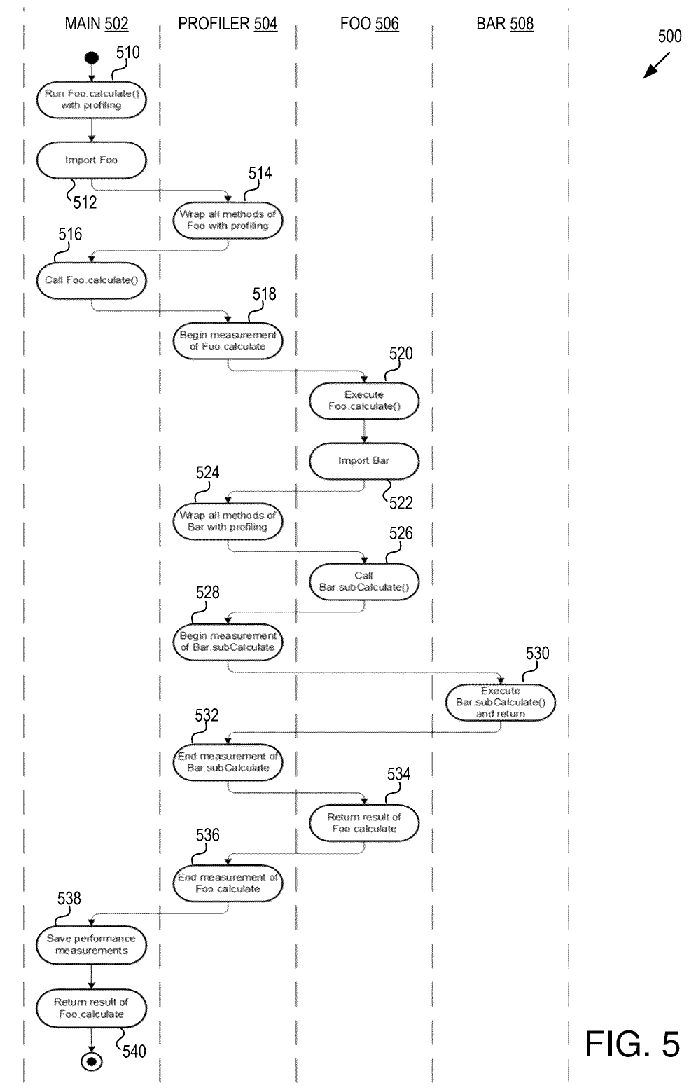

FIG. 5 is a flow diagram of an example process 500 of wrapping and profiling an imported software module and can be performed, for example, by the system of FIG. 1 (e.g., by a server such as server 102 of FIG. 1). In particular, process 500 can be performed during an active backend session between a server and a client application. In the depicted example, a software module comprising an example class Foo is imported. The class Foo includes a method Foo.calculate ( ) Execution of Foo.calculate ( ) requires import of another software module, Bar, which in turn includes a method Bar.subCalculate ( ) As shown, the actors involved in process 500 include a main thread 502, a profiler thread 504, a Foo thread 506 for the class Foo, and a Bar thread 508 for the class Bar. The threads 502, 504, 506, and 508 can be execution threads, for example.

In the example, at 510, the main thread 502 runs the method Foo.calculate ( ) with profiling. For example, a client application participating in the backend session can transmit a request to the server to perform Foo.calculate ( ) with an indication that performance profiling is desired. This triggers the main thread 502 to import the software module containing the class Foo at 512. The profiler thread 504 then wraps all methods of the class Foo with profiling at 514 in accordance with the technologies described herein.

After the methods of Foo have been wrapped with profiling, the process proceeds to 516 and the main thread 502 calls Foo.calculate ( ) Because Foo.calculate ( ) has been wrapped with profiling, execution of Foo.calculate ( ) triggers the profiler thread 504 to begin measurement of Foo.calculate at 518 (e.g., measurement of performance data associated with Foo.calculate such as its execution time).

Next, Foo.calculate ( ) is executed by the Foo thread 506 at 520. Because the Foo.calculate ( ) method includes a function call for Bar, execution of Foo.calculate ( ) triggers the class Bar to be imported at 522. Next, the profiler thread 504 wraps all methods of the class Bar with profiling at 524. After the methods of Bar have been wrapped with profiling, the process proceeds to 526 and the Foo thread 506 calls Bar.subCalculate ( ) Because all methods of Bar have been wrapped with profiling, execution of Bar.subCalculate ( ) triggers the profiler thread 504 to begin measurement of Bar.subCalculate at 528 (e.g., measurement of performance data associated with Bar.subCalculate such as its execution time).

Bar.subCalculate is then executed by the Bar thread 508 at 530 and the result is returned. At 532, the profiler thread 504 ends measurement of Bar.subCalculate, and the Foo thread 506 returns the result of Foo.calculate to the profiler thread 504 at 534. At 536, the profiler thread 504 ends the measurement of Foo.calculate. The performance measurements are then saved by the main thread 502 at 538 and stored individually. At 540, the result of Foo.calculate is returned by the main thread 502. The result of Foo.calculate returned at 540 is the same result that would have been returned if Foo.calculate had been called without performance profiling.

### Example 7)—Example Integration into Software Platform

In any of the examples herein, the technologies can be integrated into a software platform configured to host a backend session between a client application executing on a client system of a tenant of the software platform and a server of the software platform in requests from the client application for desired functionality are fulfilled by the software platform. For example, SAP Analytics Cloud available from SAP SE of Walldorf, Germany can incorporate the technologies described herein to improve processing time and reduce costs associated with software profiling.

### Example 8)—Example Software Module Storage

In any of the examples herein, the software modules and profiling-enhanced software modules can be stored as data structures, tables, or the like in a computing system. While FIG. 1 depicts software modules and profiling-enhanced software modules stored in a database of the server, the software modules and profiling-enhanced software modules can alternatively be stored in another location (e.g., external to the server). The software modules and profiling-enhanced software modules can take the form of logical objects that have properties and executable methods according to object-oriented programming paradigm. The data can be represented in data structures, database tables, or the like.

### Example 9)—Example Implementations

Any of the following can be implemented.

Clause 1. A computer-implemented method comprising: receiving a request from a client application to import a requested function during a backend session of a software platform, the request comprising an indication to enhance the requested function with profiling; and responsive to the request: importing a software module comprising the requested function with a software engine; determining that the software module does not include profiling; transforming the requested function into a profiling-enhanced function by wrapping the requested function with profiling; and outputting the profiling-enhanced function.

Clause 2. The method of Clause 1, wherein wrapping the requested function with profiling comprises executing a profiling function which receives the requested function as an argument and returns the profiling-enhanced function.

Clause 3. The method of Clause 2, wherein the profiling function, when executed, generates the profiling-enhanced function by adding computer-executable instructions to the requested function for measuring performance data associated with the requested function.

Clause 4. The method of Clause 3, wherein wrapping the requested function with profiling comprises executing the profiling function with the requested function as the argument.

Clause 5. The method of Clause 4, wherein the requested function is one of a plurality of entities included in the software module, and wherein, for each entity of the plurality of entities, executing the profiling function with the entity as the argument comprises adding, to the entity, computer-executable instructions for measuring performance data associated with the entity, wherein the performance data associated with the entity comprises an execution time of the entity and/or a number of function calls associated with execution of the entity.

Clause 6. The method of Clause 5, wherein the plurality of entities comprise one or more functions and/or one or more classes.

Clause 7. The method of Clause 6, further comprising: determining that the plurality of entities comprise a first class, the first class comprising a first method; wrapping the first class by executing the profiling function with the first class as the argument; and wrapping the first method by executing the profiling function with the first method as the argument.

Clause 8. The method of Clause 7, further comprising: determining that the first class is a subclass of a superclass; and wrapping the superclass by executing the profiling function with the superclass as the argument.

Clause 9. The method of Clause 8, wherein the superclass comprises a second method, the method further comprising: wrapping the second method by executing the profiling function with the second method as the argument.

Clause 10. The method of any one of Clauses 3-9, wherein the performance data comprises an execution time of the requested function.

Clause 11. The method of Clause 10, wherein the computer-executable instructions for measuring the performance data associated with the requested function comprise: instructions to record an execution start time of the requested function; instructions to record an execution end time of the requested function; and instructions to determine the execution time associated with the requested function as a difference between the execution end time and the execution start time.

Clause 12. The method of Clause 10 or 11, wherein the performance data further comprises a number of function calls associated with the requested function.

Clause 13. The method of any one of Clauses 1-12, wherein the requested function is a first requested function, and wherein the software module is a first software module, the method further comprising: receiving a request for a second requested function, the request for the second requested function comprising an indication to enhance the second requested function with profiling; and responsive to the request for the second requested function: importing a second software module comprising the second requested function; determining that the second requested function includes profiling; and outputting the second requested function.

Clause 14. The method of any one of Clauses 1-13, wherein the indication to enhance the requested function with profiling comprises a configuration flag with an ON value.

Clause 15. A computing system configured to host a software platform, comprising: at least one hardware processor; at least one memory coupled to the at least one hardware processor; one or more non-transitory computer-readable media having stored therein computer-executable instructions that, when executed by the computing system, cause the computing system to perform: initiating a backend session with a client application; and during the backend session: receiving a request from the client application to import a requested function, the request comprising an indication to enhance the requested function with profiling; and responsive to the request: determining that the requested function does not include profiling; importing a software module comprising the requested function with a software engine; transforming the requested function into a profiling-enhanced function by wrapping the requested function with profiling; and outputting the profiling-enhanced function.

Clause 16. The system of Clause 15, further comprising: a stored class definition of a profiler class comprising: a first method for generating a profiling function; and a second method for intercepting an import of the software module and executing the profiling function on the requested function to generate the profiling-enhanced function.

Clause 17. The system of Clause 16, wherein the profiling function is executable to receive the requested function as an argument and generate the profiling-enhanced function by adding, to the requested function, computer-executable instructions for measuring an execution time associated with the requested function.

Clause 18. The system of Clause 17, wherein the software module comprises, in addition to the requested function, one or more other functions and/or classes.

Clause 19. The system of Clause 18, wherein the software module further comprises a first class, wherein the first class comprises a first method, and wherein the system further comprises computer-executable instructions for executing the profiling function on the first class and the first method after importing the software module.

Clause 20. One or more non-transitory computer-readable media comprising computer-executable instructions that, when executed by a computing system, cause the computing system to perform operations comprising: receiving a request from a client application to import a requested function, the request comprising an indication to enhance the requested function with profiling; responsive to the request, instantiating a profiler class comprising: a first method for generating a profiling function, the profiling function being executable to receive the requested function as an argument and transform the requested function into a profiling-enhanced function by adding, to the requested function, computer-executable instructions for measuring an execution time associated with the requested function; and a second method for executing the profiling function on the requested function; executing the first method to generate the profiling function for the requested function and executing the second method to transform the requested function into the profiling-enhanced function; and outputting the profiling-enhanced function.

### Example 10)—Example Advantages

A number of advantages can be achieved via the technologies described herein.

As one example, the automatic performance profiling approach described herein can provide more comprehensive software performance data relative to conventional performance profiling techniques. In particular, automatically profiling all imported software modules and any methods therein (as well as newly added code) leads to the generation of a performance profile with fine granularity. As a result, the critical path in terms of performance is visible.

Further, the technologies described herein can provide faster analysis relate to conventional performance profiling techniques. Due to the fine granularity of the performance profiles, developers can analyze performance directly without manually changing code. This can result in a significant improvement of performance analysis duration.

Furthermore, the technologies described herein can achieve a more thorough analysis relative to conventional performance profiling techniques. For example, due to the fine granularity of the performance profile, it is possible to find statements that take up some computation time but are not really required. Such statements were usually not detected by conventional performance profiling techniques.

In addition, the technologies described herein can be implemented on code that is in production, such that performance profiling can be added to productive systems. For example, conventional profiling statements cannot be introduced into production code because developers cannot alter the code base of a productive system. In contrast, the technologies described herein allow for the incorporation of detailed performance analysis on productive systems.

Still further, the technologies described herein can facilitate handover among development teams. For example, when one development team has identified performance bottlenecks, the performance analysis can easily be reproduced by another development team. In addition, development time can be saved as developers can concentrate on feature development rather than on adding profiling statements to methods.

Another advantage associated with the technologies described herein is improved robustness. As no additional code needs to be added to the production code to run performance measurements, there is less diagnostic code in the production code and thus less room for bugs. In addition, implementation of the technologies described herein can result in a slimmer code base. As a result, loading of software modules and deployment of an application is faster because the code size has not been bloated by diagnostic statements.

Moreover, the technologies described herein can provide increased production performance relative to conventional techniques in which profiling statements were inserted anywhere in the code where performance profiling might be performed. Even when such profiling statements are not activated, their mere presence in the code poses some computation overhead (e.g., as the presence of inactive profiling statements results in function calls which consume a few microseconds of the overall call chain for the code of a given session). In a typical session, there could be thousands of profiling statements which ultimately consume hundreds of milliseconds even when inactive. Because the technologies described herein do not insert such statements throughout the code, performance is improved and processing time is reduced relative to the convention techniques. For example, although a single function call may only take a few nanoseconds, thousands of compute hours can be saved when the technologies described herein are incorporated in a large production system.

The described technologies thus offer considerable improvements over conventional performance profiling techniques.

### Example 11)—Example Computing Systems

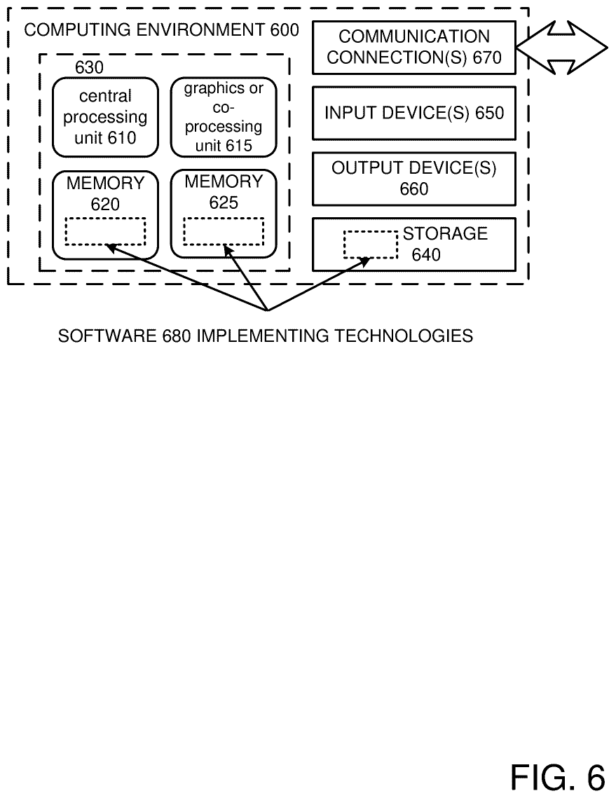

FIG. 6 depicts an example of a suitable computing system 600 in which the described innovations can be implemented. The computing system 600 is not intended to suggest any limitation as to scope of use or functionality of the present disclosure, as the innovations can be implemented in diverse computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 can be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615.

A computing system 600 can have additional features. For example, the computing system 600 includes storage 640, one or more input devices 650, one or more output devices 660, and one or more communication connections 670, including input devices, output devices, and communication connections for interacting with a user. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 can be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 can be an input device such as a keyboard, mouse, pen, or trackball, a voice input device, a scanning device, touch device (e.g., touchpad, display, or the like) or another device that provides input to the computing system 600. The output device(s) 660 can be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 12)—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 13)—Example Cloud Computing Environment

FIG. 7 depicts an example cloud computing environment 700 in which the described technologies can be implemented, including, e.g., the system 100 of FIG. 1 and other systems herein. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

In practice, cloud-based, on-premises-based, or hybrid scenarios can be supported.

### Example 14)—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 15)—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a request from a client application to import a requested function during a backend session of a software platform, the request comprising an indication to enhance the requested function with profiling; and
responsive to the request:
importing a software module comprising the requested function with a software engine;
determining that the software module does not include profiling;
transforming the requested function into a profiling-enhanced function by wrapping the requested function with profiling; and
outputting the profiling-enhanced function.

2. The method of claim 1, wherein wrapping the requested function with profiling comprises executing a profiling function which receives the requested function as an argument and returns the profiling-enhanced function.

3. The method of claim 2, wherein the profiling function, when executed, generates the profiling-enhanced function by adding computer-executable instructions to the requested function for measuring performance data associated with the requested function.

4. The method of claim 3, wherein wrapping the requested function with profiling comprises executing the profiling function with the requested function as the argument.

5. The method of claim 4, wherein the requested function is one of a plurality of entities included in the software module, and wherein, for each entity of the plurality of entities, executing the profiling function with the entity as the argument comprises adding, to the entity, computer-executable instructions for measuring performance data associated with the entity, wherein the performance data associated with the entity comprises an execution time of the entity and/or a number of function calls associated with execution of the entity.

6. The method of claim 5, wherein the plurality of entities comprises one or more functions and/or one or more classes.

7. The method of claim 6, further comprising:
determining that the plurality of entities comprise a first class, the first class comprising a first method;
wrapping the first class by executing the profiling function with the first class as the argument; and
wrapping the first method by executing the profiling function with the first method as the argument.

8. The method of claim 7, further comprising:
determining that the first class is a subclass of a superclass; and
wrapping the superclass by executing the profiling function with the superclass as the argument.

9. The method of claim 8, wherein the superclass comprises a second method, the method further comprising:
wrapping the second method by executing the profiling function with the second method as the argument.

10. The method of claim 3, wherein the performance data comprises an execution time of the requested function.

11. The method of claim 10, wherein the computer-executable instructions for measuring the performance data associated with the requested function comprise:
instructions to record an execution start time of the requested function;
instructions to record an execution end time of the requested function; and
instructions to determine the execution time associated with the requested function as a difference between the execution end time and the execution start time.

12. The method of claim 10, wherein the performance data further comprises a number of function calls associated with the requested function.

13. The method of claim 1, wherein the requested function is a first requested function, and wherein the software module is a first software module, the method further comprising:
receiving a request for a second requested function, the request for the second requested function comprising an indication to enhance the second requested function with profiling; and
responsive to the request for the second requested function:
importing a second software module comprising the second requested function;
determining that the second requested function includes profiling; and
outputting the second requested function.

14. The method of claim 1, wherein the indication to enhance the requested function with profiling comprises a configuration flag with an ON value.

15. A computing system configured to host a software platform, comprising:
at least one hardware processor;
at least one memory coupled to the at least one hardware processor;
one or more non-transitory computer-readable media having stored therein computer-executable instructions that, when executed by the computing system, cause the computing system to perform:
initiating a backend session with a client application; and
during the backend session:
receiving a request from the client application to import a requested function, the request comprising an indication to enhance the requested function with profiling; and
responsive to the request:
determining that the requested function does not include profiling;
importing a software module comprising the requested function with a software engine;
transforming the requested function into a profiling-enhanced function by wrapping the requested function with profiling; and
outputting the profiling-enhanced function.

16. The system of claim 15, further comprising:
a stored class definition of a profiler class comprising:
a first method for generating a profiling function; and
a second method for intercepting an import of the software module and executing the profiling function on the requested function to generate the profiling-enhanced function.

17. The system of claim 16, wherein the profiling function is executable to receive the requested function as an argument and generate the profiling-enhanced function by adding, to the requested function, computer-executable instructions for measuring an execution time associated with the requested function.

18. The system of claim 17, wherein the software module comprises, in addition to the requested function, one or more other functions and/or one or more classes.

19. The system of claim 18, wherein the software module further comprises a first class, wherein the first class comprises a first method, and wherein the system further comprises computer-executable instructions for executing the profiling function on the first class and the first method after importing the software module.

20. One or more non-transitory computer-readable media comprising computer-executable instructions that, when executed by a computing system, cause the computing system to perform operations comprising:
receiving a request from a client application to import a requested function, the request comprising an indication to enhance the requested function with profiling;
responsive to the request, instantiating a profiler class comprising:
a first method for generating a profiling function, the profiling function being executable to receive the requested function as an argument and transform the requested function into a profiling-enhanced function by adding, to the requested function, computer-executable instructions for measuring an execution time associated with the requested function; and
a second method for executing the profiling function on the requested function;
executing the first method to generate the profiling function for the requested function and executing the second method to transform the requested function into the profiling-enhanced function; and
outputting the profiling-enhanced function.
